(19) United States
(12) Patent Application Publication
(10) Pub. No.: US 2011/0230085 A1
(43) Pub. Date: Sep. 22, 2011

(54) TRAILER JACK WITH ELECTRICAL PLUG STORAGE

(75) Inventors: Dennis A. CASTAGNOLA, West Linn, OR (US); Steven J. PAVENTY, Sandy, OR (US)

(73) Assignee: THE COAST DISTRIBUTION SYSTEM, INC., Morgan Hill, CA (US)

(21) Appl. No.: 12/725,087

(22) Filed: Mar. 16, 2010

(51) Int. Cl. H01R 13/60

(52) U.S. Cl. 439/528

(57) ABSTRACT

A plug storage assembly mounted to a jack. The jack may be used for raising and lowering a trailer through use of an electric motor configured to actuate the jack, with power supplied to the motor by a cord with a plug, the plug having a plug body and a distal end. The plug storage assembly is configured to support the plug with the distal end of the plug covered so that the plug is protected from environmental conditions.

### TECHNICAL FIELD

The present disclosure relates generally to a trailer jack with an electrical plug storage assembly, and more specifically to a trailer jack with an electrical plug storage assembly configured to support a plug with the distal end of the plug covered so that the plug is protected from environmental conditions.

### BACKGROUND

Trailers, for example, horse trailers and other cargo trailers, and campers and other recreational vehicle trailers, can be attached to and towed by a towing vehicle. Generally, when the trailer is stowed or not in use, the front end of the trailer is maintained in a raised position, often by use of one or more jacks that can be powered hydraulically, pneumatically, or electrically. Power for the one or more jacks may be supplied by connection to an existing trailer battery, or from any other power means, via an electrical cord and/or plug. Typically, when not actively providing power to the jack, the cord is unplugged from the power source and the plug is not protected. An unprotected cord and plug may be damaged by environmental conditions, such as rain and snow. Furthermore, depending on the length of the cord, the cord may additionally become tangled, misplaced or run over by a passing vehicle. Accordingly, it is desirable to protect the plug and/or maintain the plug in an easily accessible location with respect to the jack.

### BRIEF DESCRIPTION OF THE DRAWINGS

FIG. 1 is a side elevational view of a jack and plug storage assembly in accordance with the present disclosure.

FIG. 2 is a partial perspective view of the jack and plug storage assembly of FIG. 1, with a cord having a plug in accordance with the present disclosure.

FIG. 3 is a partial side cross-section view of the jack and plug storage assembly of FIG. 1.

### DETAILED DESCRIPTION

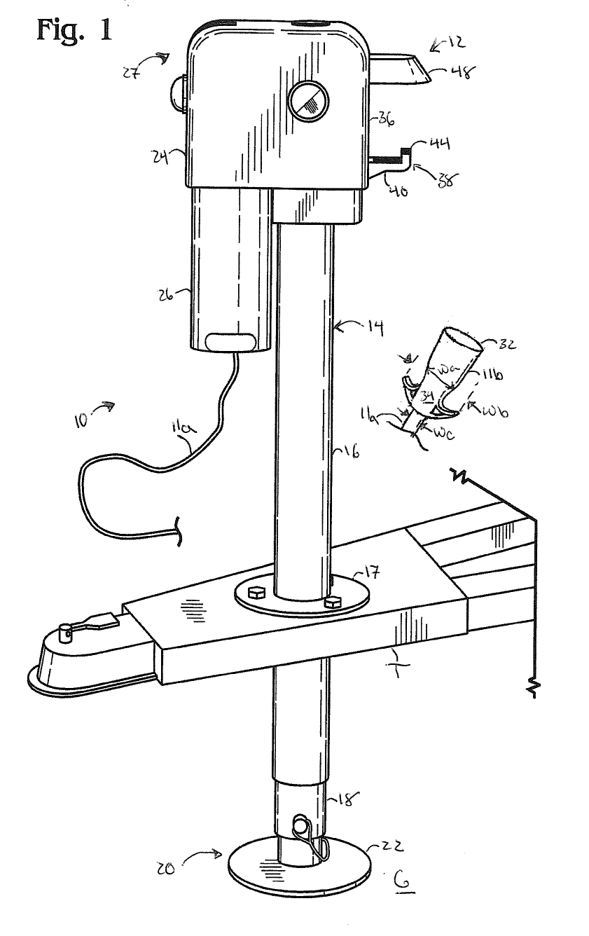

Referring to FIG. 1, the present disclosure provides a jack, indicated generally at 10, which typically may be attached to a trailer, for example a tongue of the travel trailer T, by any means known in the art. A cable 11a extends from jack 10, and includes a plug 11b at one end shaped for connection to a corresponding power socket (not shown), typically located on a travel trailer battery (not shown) or vehicle towing the trailer (not shown). A plug storage assembly 12 may be mounted to jack 10, and is configured to support plug 11b, and cover an end of plug 11b such that plug 11b is supported off of the ground and is at least partially shielded, for example from outside elements such as weather.

Generally, jack 10 may be of any standard construction known to one skilled in the art. For example, jack 10 may be an electrically driven unit that is powered by an existing travel trailer battery (not shown). Jack 10 may include a telescoping assembly 14 including an elongate vertical fixed column or post 16 that may be mounted to the tongue of travel trailer T, by an annular mounting flange 17 via bolts or any other known mounting means. Telescoping assembly 14 may further include an extendable vertical column or post 18 that may be telescopingly engaged with fixed column 16 and may have a support plate or foot 22 at a bottom or second end 23. Foot 22 may rest on any ground surface G.

A housing 24 and an electric motor 26 may be connected to an upper or first end 27 of the telescoping assembly 14. Motor 26 may be controlled by control switches (not shown) on housing 24 and may drive the upwards and downwards movement of post 18 in accordance with any manner known to those skilled in the art. Motor 26 may be connected by cable 11a and plug 11b to any available power source to power the motor 26. Any other and/or additional configuration of jack 10 and power means known in the art may also be used in accordance of the present disclosure.

Plug 11b is shown to include a distal end 32 and a plug body 34, and plug storage assembly 12 may be configured to support plug 11b and to cover at least plug distal end 32. Plug storage assembly 12 may be mounted to any surface of jack 10 via screws or any other known mounting means. Plug storage assembly 12 may be mounted to a face 36 of housing 24 such that plug storage assembly 12 at least partially extends from housing 24. Additionally, and/or alternatively, plug storage assembly 12 may be mounted above mounting flange 17 with respect to the ground surface G, such that plug storage assembly 12 is above the trailer tongue T and easily accessible to a user.

Referring to FIGS. 1-3, some embodiments of plug storage assembly 12 may include a plug seat 38 configured to support plug 11b above the ground surface G such that a portion of the plug rests on the plug seat 38. Additionally, plug seat 38 may be configured to support plug 11b on opposite sides of plug body 34. For example, plug seat 38 may include two or more cantilever members 40 extending from face 36 of housing 24. Support lengths 42 of cantilever members 40 may extend at a 90-degree angle with respect to the ground surface G and may be substantially planar. Additionally and/or alternatively, a portion of cantilever members 40 may be obtusely angled with respect to the ground surface and/or may include a curved portion.

The length of cantilever members 40 and the distance between the cantilever members may vary depending on the size and various widths of plug 11b. For example, the distance between the support members may be 30.5 mm (1.20 inches). The length of the support members may be 31.8 mm (1.25 inches). In some embodiments, plug body 34 may have various widths at different points of plug body 34, may taper and/or may have one or more extensions off of plug body 34. In some embodiments, support length 42 may be at least as long as a narrow-most width Wa of the plug body 34. The distance between the support lengths may be at least as wide as the width Wa of the plug body 34 but smaller than a largest width of the plug body Wb, such that a portion of the plug body 34 rests on the support lengths 42. The distance between the support lengths is at least as wide as the width We of the cord 11a.

Plug seat 38 may be configured to prevent plug 11b from moving away from jack 10 when plug body 34 is seated in plug seat 38. For example, the two or more cantilever members 40 may each have a stop member 44 at a distal end of cantilever members 40 with respect to face 36 of housing 24. Stop member 44 may extend upwardly away from the ground surface G and may additionally and/or alternatively extend inwardly towards second cantilever member 40. For example, the distance between the stop members may be 15.9 mm (0.63 inches). The stop members may extend 7.6 mm (0.30 inches) above the support members.

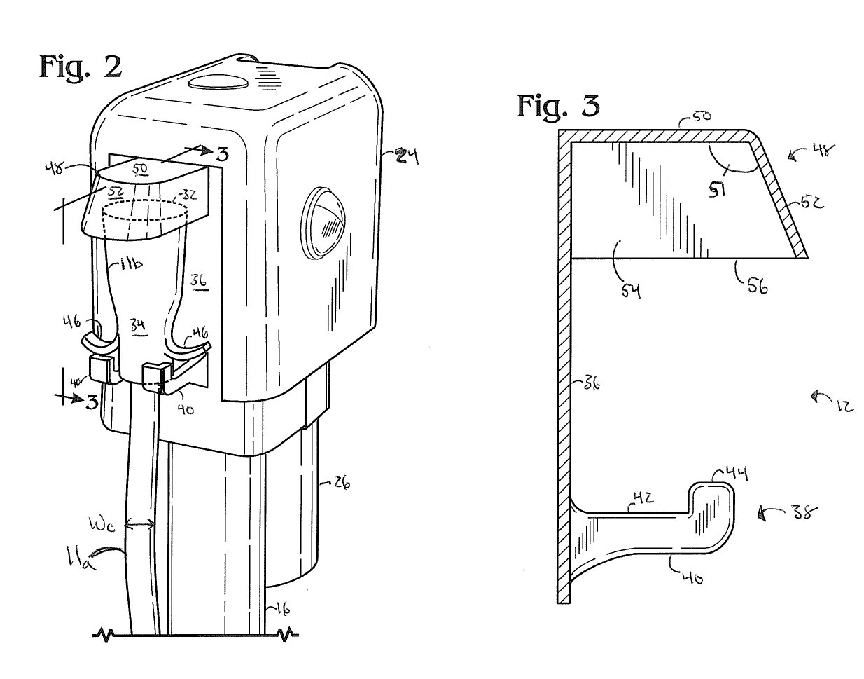

Referring now to FIG. 2, as discussed above jack 10 may include plug 11b having plug body 34. In accordance with the present disclosure, plug 11b may be configured to be supported by plug storage assembly 12. For example, plug body 34 may include extensions 46 branching off of opposite sides of plug body 34. Extensions 46 may include an arcuate portion extending towards distal end 32 of plug 11b.

As described earlier, plug storage assembly 12 may have any configuration such that at least distal end 32 of plug 11b is partially covered and/or shielded. For example, plug storage assembly 12 may include a cover member 48. Cover member 48 may project from face 36 of housing 24 and may include a lid 50 and a skirt 52 extending from lid 50, which resemble a hood or awning under which distal end 32 of plug 11b may be shielded. The length and width of cover member 48 may vary depending on the size of the plug 11b.

Cover member 48 may be configured to shield distal end 32 of plug body 34 and at least a portion of plug body 34. For example, cover member 48 may include a recessed portion 54 closed at lid 50 and having an opening 56. The closed portion at lid 50 may be approximately the size of distal end 32 of plug body 34 and opening 56 may be larger than distal end 32 of plug body 34. For example, a portion of skirt 52 may extend from lid 50 at an obtuse angle 51 such that plug 11b may be more easily inserted and removed from the recessed potion. In some embodiments, obtuse angle 51 may be approximately 112.7-degrees.

Cover member 48 may be spaced from plug seat 38 such that the distance between cover member 48 and plug seat 38 may be approximately equal to the length of plug body 34. In embodiments of cover member 48 including recessed portion 54, the distance between cover member opening 56 and plug seat 38 may be less than the length of plug body 34. For example, the distance between the lid of the cover member and the support members may be 101.6 mm (4.00 inches). The distance between the lid and the cover member opening may be 34.9 mm (1.38 inches).

Cover member opening 56 may be directed towards plug seat 38 and/or the ground surface G such that plug is at least partially shielded from environmental conditions such as rain or snow. In plug storage assembly 12 shown in FIGS. 1-3, the longitudinal axis of plug body 34 is orientated to be approximately parallel with the longitudinal axis of telescoping assembly 14; however, other embodiments may include a plug storage assembly having a different orientation relative to telescoping assembly 14.

The components of the plug storage assembly expressed so far descriptively may be mounted on a framework that supports such components so that they are positioned for the maximum mechanical and operational advantage inherently possible between the components. Scaling of the individual components, and overall assembly proportions, are variable and relative to the users' operational specifications.

With respect to the above description then, it is to be realized that the optimum dimensional relationships for the parts of the claimed jack for use with a trailer, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

Therefore, the foregoing is considered as illustrative only of the principles of the system. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

What is claimed is:

1. A jack for raising and lowering a trailer, comprising:
an electric motor configured to actuate the jack, the motor including a cord with a plug, the plug having a plug body and a distal end; and
a plug storage assembly mounted to the motor configured to support the plug with the distal end of the plug covered, the plug storage assembly including a plug seat extending on either side of the plug such that the plug rests on the plug seat.

2. The jack of claim 1, wherein the plug storage assembly includes a cover member extending to shield the distal end of the plug.

3. The jack of claim 2, wherein the cover member receives the plug in a recessed portion such that at least a portion of the plug body is covered.

4. The jack of claim 1, wherein the plug body includes extensions branching off of opposite sides of the plug body, configured to rest on the plug seat.

5. The jack of claim 4, wherein at least two of the extensions include an arcuate portion extending towards the distal end of the plug.

6. The jack of claim 1, wherein the plug seat includes two symmetrically extending cantilever members, each of the cantilever members including a support length, wherein a distance between the support lengths is greater than a width of the cord.

7. The jack of claim 6, wherein the distance between the two cantilever members is greater than a width of the plug body.

8. The jack of claim 7, wherein each of the two cantilever members includes a stop at a distal end of the support length configured to prevent the plug body from moving away from the plug seat.

9. The jack of claim 2, wherein the recessed portion of the cover member includes a sloped distal end such that a closed end of the recessed portion is smaller than an open end of the recessed portion.

10. A jack for use with a trailer, comprising:
a jack assembly having a motor, wherein the motor includes a cord and a plug, the plug having a plug body and a distal end; and
a plug storage assembly extending from the jack assembly including:
a plug seat configured to support the plug body such that the widest portion of the plug body rests on the plug seat, and
a cover member configured to shield at least the distal end of the plug body.

11. The jack of claim 10, wherein the plug includes extensions branching off of opposite sides of the plug body, configured for support by the plug seat.

12. The jack of claim 11, wherein each of the extensions includes an arcuate portion extending towards the distal end of the plug.

13. The jack of claim 11, wherein the plug seat includes cantilever members extending from a face of the jack assembly, the cantilever members having support lengths configured to support the extensions branching off of opposite sides of the plug body.

14. The jack of claim 13, wherein each of the cantilever members includes a stop configured to prevent the plug body from moving away from the face of the jack assembly.

15. The jack of claim 13, wherein a distance between the support lengths is greater than a width of the cord.

16. The jack of claim 13, wherein the distance between the support lengths is greater than a narrow-most width of the plug body.

17. The jack of claim 10, wherein the cover member includes a recessed portion and opening defined by a skirt extending from a lid, wherein the opening is larger than the lid.

18. A jack for use with a trailer, comprising:
a telescoping assembly configured to be affixed to a trailer;
a foot member attached to a free end of the telescoping assembly;
a motor configured to actuate the telescoping assembly, the motor including a cord and a plug, the plug having a plug body with a distal end and extensions branching off of opposite sides of the plug body;
a plug seat including cantilever members extending from the telescoping assembly, the cantilever members configured to symmetrically extend on opposite sides of the plug body such that each of the plug extensions rests on a cantilever member and the cantilever members support the plug body adjacent the telescoping assembly; and
a cover member extending from the telescoping assembly and including a recessed portion directed towards the plug seat and the foot member, wherein the cover member receives the plug in the recessed portion such that at least a portion of the plug body is covered, the cover member including a lid and a skirt, wherein at least a portion of the skirt extends at an obtuse angle with respect to the lid.

19. The jack of claim 18, wherein the cover member shields the distal end of the plug body.

20. The jack of claim 18, wherein each of the cantilever members includes a stop configured to prevent the plug body from moving away from the telescoping assembly.
